(19) United States
(12) Patent Application Publication
(10) Pub. No.: US 2012/0271722 A1
(43) Pub. Date: Oct. 25, 2012

(54) Top Friend Prediction for Users in a Social Networking System

(76) Inventors: Yun-Fang Juan, (US); Ming Hua, (US)

(21) Appl. No.: 13/093,744

(22) Filed: Apr. 25, 2011

(51) Int. Cl. G06Q 30/02; G06F 15/18

(52) U.S. Cl. 705/14.72; 706/12

(57) ABSTRACT

A social networking system predicts a user's top friends among the user's connections in a social networking system. A top friend prediction model receives static data and statistics related to the historical interactions of the connection and the user as input singles. The model may be trained using a training set of data associated with the connections of users, where users have explicitly indicated that other users are or are not their top (or “best” or “closest”) friends. The trained model outputs a score for each of a particular user's connections, and the score is used to predict whether the connection is a top friend of that user. Whether a user's connection is one of that user's top friends thus indicates a closeness of that relationship in the real world, which may differ from how likely the users are to interact with each other within the social networking system.

### BACKGROUND

This invention relates generally to social networking, and in particular to predicting a user's top friends among the user's connections in a social networking system.

Social networking systems allow users to designate other users as connections or otherwise connect to or form relationships with other users. Within a social networking system, users can contribute and interact with media items, use applications, join groups, list and confirm attendance at events, invite connections, and perform other tasks that facilitate social interaction among their connections. External applications also use the functionalities of social networking systems and allow authenticated users to perform some of the above actions.

When establishing relationships with other users in a social networking system, a user typically forms the new relationships without explicitly indicating the strength of those relationships. Users may also declare a relationship type for a particular relationship (e.g., friend, family member, co-worker, etc.), but those declarations merely indicate the type of relationship. They do not indicate how close the user is with the connection in the real world. Social networking systems have attempted to infer a user's affinity (or closeness) to other users based on the interactions among the users. However, these affinity algorithms are really predicting the likelihood of future online interactions between the users, not how close the two connections are in real life. This is because users may interact more with certain connection than others for reasons that have little or nothing to do with how close of friends they are. For example, a user may interact online much more with a distant acquaintance than with a best friend if that acquaintance posts higher quality content to the social networking system than the best friend.

Accordingly, while predicting future interactions is very useful in a social networking system, affinity algorithms have their limitations. In addition to existing affinity algorithms, therefore, it would be useful to predict whether a particular connection of a user is among that user's top friends, which may include the user's best friends in real life. By identifying a user's top friends, the social networking system can engage the user and foster desired activity in various circumstances where existing affinity algorithms are insufficient.

### SUMMARY

In a social networking system environment, it may be beneficial to predict a user's top friends among the user's connections in a social networking system. A list of the top friends for a user may reflect the user's social networking system connections with whom the user has a closest relationship in the real world. As such, these top friends may be used for various useful purposes by the social networking system, such as social endorsements for advertising, suggestions for joining groups, and offering group deals, just to list a few examples.

In one embodiment, the social networking system predicts a user's top friends using a top friend prediction model. The model may take as inputs various types of information about the user and the user's connections, such as information about the users' interactions. This interaction information may include actions such as one user observing information about or communicating with another user, coincidental information (e.g., two users tagged in the same photograph), and farmed data. The farmed data may be obtained by providing users with options to interact with one or more other users and monitoring the responses to the suggestions. The model may also take as inputs various types of declared static information, which includes information in a user's profile. For example, the static data may indicate persistent interest based on commonalities, such as workplace, school, or hobbies. Moreover, and of the inputs to the model may be decayed based on time and normalized (e.g., to account for differences in each user's tendency to perform certain actions, like tagging others in photographs).

Embodiments of the invention use the top friend prediction model to compute a score for each of a user's connections. Based at least in part on the score, the social networking system identifies those connections that are the user's top friends, which may then be provided to another process running in the social networking system or even external to the social networking system.

The scoring function performed by the top friend prediction model may be determined by training the model using machine learning algorithms, such as supervised training In one embodiment of the invention, the training set comprises keyword tags, both positive and negative, with which users of the social networking system indicate whether other users are their top friends. For example, the social networking system may identify users who have added groups of friends to friend lists that are named “best friends,” and the explicitly identified best friends for those users may be used to train the model. The absence of a positive keyword tag with a connection may constitute a negative example for the training set, and vice versa. In other embodiments of the invention, farmed data may be used for the training set for the machine learning algorithm. For example, users may be prompted to add certain of their connections to a top friends or “best” friends list.

The methods described herein may be extended to objects in the social networking system other than users. In addition to users, other types of objects in a social networking system may include content items, applications, games, search results, groups, locations, and fan pages. Accordingly, in addition to predicting a user's top friends, other embodiments may predict a user's favorite content items, applications, games, groups, locations, and fan pages. As discussed above, the social networking system may maintain for each object information about the object and historical interactions between the object and other users. Similar to the top friend prediction model, statistics related to the historical interactions of a user and the object along with static data from the profiles of the user and the object may be used to train the model that computes a score indicating whether that object is among a user's favorites. As with top friends, a user's favorite game may not actually be the game that the user interacts with the most. Accordingly, this prediction is distinct from an affinity algorithm that predicts how likely the user is to interact with an object (e.g., play the game). Based on at least the score for each object, the social networking system returns a list of top objects to a requesting process.

### BRIEF DESCRIPTION OF THE DRAWINGS

FIG. 1 is a block diagram of a social networking system, in accordance with an embodiment of the invention.

FIG. 2 is an exemplary flow chart of a process for determining the top friends for a user, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

In certain situations, it may be beneficial for the social networking system to predict a set of top friends for a user, where the top friends represent the closest friends of the user from that user's perspective. A user's top friends may be correlated with the other users that a user most often interacts with or is most likely to interact with, but they may be different. In the social networking environment, any one of a number of processes may request a list of top friends from among the user's connections. For example, an advertising module may request a user's top friends so that it can incorporate a social endorsement from one of those friends into an advertisement to be served to the user. Similarly, any one of a number of processes may request a list of top objects for the user, where the top objects represent the user's favorite objects (e.g., favorite games, groups, etc.). Although embodiments of the invention are described in terms of predicting top friends, these techniques can be extended to predict a user's favorite objects of any of a variety of object types.

To predict a user's top friends, the social networking system uses a prediction model to compute a score for each connection. The prediction model computes the score using a scoring function that takes as input statistics related to historical interactions of the user and the user's connections. These inputs may be normalized (e.g., based on the frequency that users perform certain actions) and/or weighted by recency (e.g., more recent interactions being accorded higher weight). The scoring function may also take as input static data from profiles of the user and the user's connections. Static data from profiles may include details such as where the user went to college, where the user works, where the user lives, and other information about the user. This static information may be useful in identifying commonalities between the user and the user's connections. For example, whether the user and a particular connection live in the same city or work together may be strong signals for predicting the closeness of their relationship.

An online social networking system allows users to associate themselves and establish connections with other users of the social networking system. When two users become connected, they are said to be “connections,” “friends,” “contacts,” or “associates” within the context of the social networking system. Being connected in a social networking system may allow connected users access to more information about each other than would otherwise be available to unconnected users. Likewise, becoming connected within a social networking system may allow a user greater access to communicate with another user, such as by email (internal and external to the social networking system), instant message, text message, phone, or any other communicative interface. Finally, being connected may allow a user access to view, comment on, download or endorse another user's uploaded content items. Examples of content items include but are not limited to messages, queued messages (e.g., email), text and SMS (short message service) messages, comment messages, messages sent using any other suitable messaging technique, an HTTP link, HTML files, images, videos, audio clips, documents, document edits, calendar entries or events, and other computer-related files.

Users of social networking systems may interact with objects. This interaction may take a variety of forms, such as by communicating with or commenting on the object; clicking a button or link associated with affinity (such as a “like” button); sharing a content item, user information or user actions with other users; downloading or merely viewing a content item; or by any other suitable means for interaction. Users of a social networking system may also interact with other users by connecting or becoming friends with them, communicating with them, or having common connections within the social networking system. Further, a user of a social networking system may form or join groups, or may like a fan page. Finally, a social networking system user may interact with content items, websites, other users or other information outside of the context of the social networking system's web pages that are connected to or associated with the social networking system. For instance, an article on a news web site might have a “like” button that users of the social networking system can click on to express approval of the article. Any action that a particular user takes with respect to another user is associated with each user's profile, through information maintained in a database or other data repository. These actions may include, for example, adding a link to the other user, sending a message to the other user, reading a message from the other user, viewing content associated with the other user, attending an event posted by another user, among others. These interactions may be recorded in social networking system data and represented by on a “social graph.”

In one embodiment, the social networking system maintains a user profile for each user. The user profiles include static data for a user, such as work experience, educational history, hobbies or preferences, geographic location. A user profile may also include data describing one or more relationships with other users, such as data indicating an established connection with another user and/or data indicating others users having similar or common work experience, hobbies, or educational history. Users can also post messages specifically to their profiles in the form of status updates. Users of a social networking system may view the profiles of other users.

Beyond the users themselves, other types of objects in the social networking system may have a profile associated with them. These other types of objects may include content items, applications, games, groups, locations, and fan pages. The profile for an object may contain static data describing the object. For example, the static data for a fan page may include a location, an external website, and content items posted to the fan page. The social graph, maintained in a database or other data repository, may be used to track interactions between users and these objects.

In some embodiments, the social networking system attempts to deliver the most relevant information to each user using algorithms to filter the raw content on the network. Content may be filtered based on the attributes in a user's profile, such as geographic location, employer, job type, age, music preferences, interests, or other attributes. For example, newsfeed stories may be generated to deliver the most relevant information to a user based on a ranking of the generated content, filtered by the user's affinity, or attributes. Similarly, social endorsement information may be used to provide social context for advertisements that are shown to a particular viewing user.

The social networking system also provides application developers with the ability to create applications that extend the functionality of the social networking system to provide new ways for users to interact with each other. For example, an application may provide an interesting way for a user to communicate with other users, or allow users to participate in multiplayer games, or collect some interesting information such as news related to a specific topic and display it to the user periodically. The social networking system thus provides a platform to the applications, which may also be represented as objects in the social networking system.

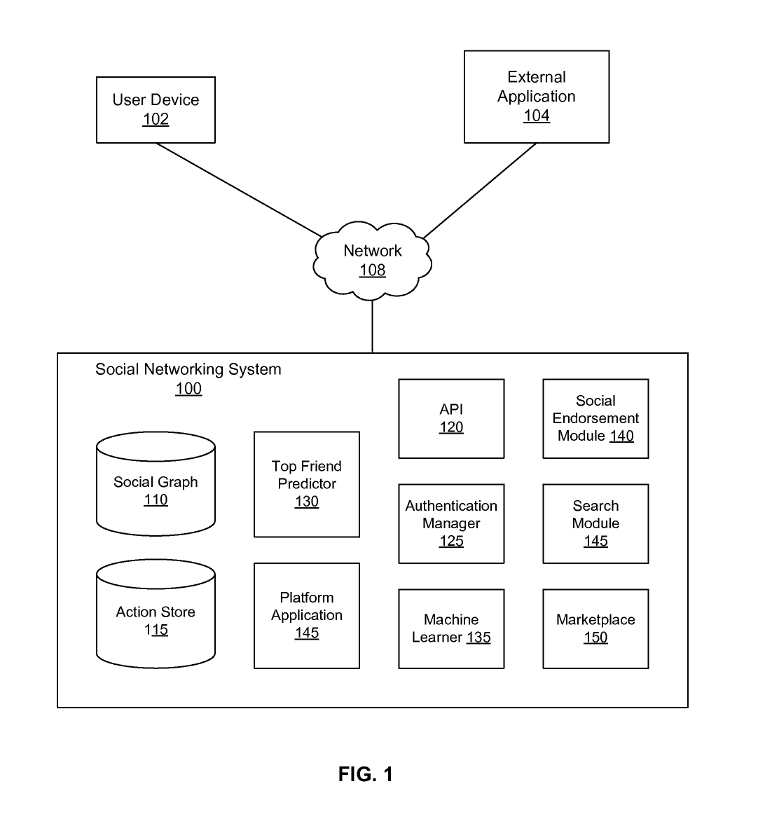

FIG. 1 is a high-level block diagram of the environment of a social networking system according to one embodiment. FIG. 1 illustrates a social networking system 100, a user device 102, an external application 104 and an ad server 106 connected by a network 108.

A user interacts with the social networking system 100 using a user device 102, such as a personal computer or a mobile phone. The user device 102 may communicate with the social networking system 100 via an application such as a web browser or native application. Typical interactions between the user device 102 and the social networking system 100 include operations such as viewing profiles of other users of the social networking system 100, contributing and interacting with media items, joining groups, listing and confirming attendance at events, checking in at locations, liking certain pages, creating pages, and performing other tasks that facilitate social interaction.

The social networking system 100 comprises a number of components used to store information about its users and objects represented in the social networking environment, as well as the relationships among the users and objects. The social networking system 100 additionally comprises components to enable several actions to user devices of the system, as described above.

The social graph 110 stores the connections that each user has with other users of the social networking system 100. The social graph 110 may also store second-order connections, in some embodiments. The connections may thus be direct or indirect. For example, if user A is a first-order connection of user B but not of user C, and B is a first-order connection of C, then C is a second-order connection of A on the social graph 110.

The action store 115 stores actions that have been performed by the users of the social networking system 100. The actions may include an indication of the time associated with those actions and references to any objects related to the actions. Additionally, the action store 115 may store statistics related to historical interactions between users and objects. For example, the action store 115 may contain the number of wall posts in 30 days by a user, number of photos posted by the user in 30 days and number of distinct users that received the user's comments in 30 days. For a given link between two users, user A and user B, the action store may contain actions such as the number of profile page views from A to B, the number of photo page views from A to B, and the number of times A and B were tagged in the same photo, and these actions may be associated with a timestamp or may be filtered by a cutoff (e.g., 24 hours, 90 days, etc.). The actions recorded in the action store 115 may be farmed actions, which are performed by a user in response to the social networking system 100 providing suggested choices of actions to the user.

The top friend predictor 130 is responsible for computing a score, which predicts how likely it is that a user will interact with a connection. The score may be representative of a user's interest in interacting with the connection. The historical interactions of the user with the connection may be used as a signal of the user's future interest in similar interactions with the connection. In some embodiments, a scoring function is used to produce the score. The scoring function takes as input statistics related to the historical interactions and may be generated using a machine learned algorithm in machine learner 135. The scoring function may use a decay factor in which the strength of the signal from a user's historical activity decays with time. Moreover, different types of historical activity may decay at different rates. Some types of user activity, for example, adding a new connection that is already linked to connection, indicate a more persistent interest in connection than other types of activity that indicate a more ephemeral interest, for example commenting on the connection's status. Therefore, the scoring function may decay the effect of historical activity based on an understanding about how that activity may become less relevant over the passage of time. Various decay mechanisms may be used for this purpose. For example, the scoring function may use a mathematical function, such as an exponential decay, to decay the statistics about a user behavior. In another embodiment, the decay is implemented by selecting only those statistics about a user behavior that occurred within a specific window of time, such as 24 hours or 30 days.

The scoring function may also be computed differently depending on the process that requests the top friends. Additionally, in certain embodiments of the invention, the scoring function may take as input relevant static data for the user and the connection. For example, static data for the user and the connection indicating that they share the same hobby or belong to the same workplace is relevant to computing the score.

In one embodiment, the scoring function is realized as a ratio of two affine functions as shown in equation (1). The numerator and denominator affine functions take statistics related to the user's historical interactions and static data as inputs.

$$P = \frac{{a}_{0} + {a}_{1} {x}_{1} + {a}_{2} {x}_{2} + … + {a}_{N} {x}_{N}}{{b}_{0} + {b}_{1} {x}_{N + 1} + … + {b}_{M} {x}_{N + M}} \qquad ( 1 )$$

where
P is the scoring function;
aᵢ for i=0, 1, 2, . . . , N are the coefficients in the numerator affine function;
bᵢ for i=0, 1, 2, . . . , M are the coefficients in the denominator affine function; and
xᵢ for i=1, 2, . . . , N+M are the statistics related to a user's historical interactions and static data.
   The denominator affine function can represent a normalization of the numerator affine function. For example, the number of comments made by a user may be normalized by, among other statistics, the number of times the user has been active on the social networking system 100. In particular, by altering bᵢ for i=0, 1, 2, . . . , M the normalization pattern can be changed.

Some examples of the statistics related to the historical interactions of a user are the number of days within the last 90 days when the user interacted with the connection, the number of days within the last 60 days when the user interacted with the connection, the number of days within the last 90 days when the user viewed the profile of the connection, the number of times within the last 90 days when the user and the connection appeared in the same thread. Some examples of the statistics related to the historical interactions of the user that are input to the denominator affine function are the number of photos posted by the user in the last 30 days, the number of comments posted by the user in the last 30 days.

In particular, the scoring function may take as input statistics related to a user's coincidence with the connection. The statistics related to coincidence may include, for example, the number of times the user and the connection have been tagged in the same photograph, have checked in at the same location, or have confirmed (e.g., via RSVP) that they will be attending the same event.

In some embodiments, some or all of the coefficients, aᵢ for i=0, 1, 2, . . . , N and bᵢ for i=0, 1, 2, . . . , M, are determined through machine learning, which may be implemented by the machine learner 135. The scoring function may also be non-linear. An exemplary embodiment implements a scoring function for a family where the scoring function includes an ‘if-then’ construct for the users of the family—i.e., the scoring function is computed differently depending on whether it is being computed for the parents or the children.

The machine learner 135 implements machine learning algorithms to determine the coefficients in the scoring function used to determine top friends. In one embodiment of the invention, supervised learning is used with positive and negative examples drawn from keyword tags some users of the social networking system 100 associate with a subset of their connections. Examples of keywords include “best friend,” “people I do not know,” and “just met.” While being associated with the tag “best friend” may qualify the connection as a positive example, tags such as “people I do not know” and “just met” qualify a connection as a negative example in some embodiments. Additionally, if a user of the social networking system 100 has tagged many of the user's connections, the absence of a tag on a connection may imply that the user did not consider the tag applicable to the connection. In such a scenario, if being associated with a tag makes a connection a positive example, not being associated with the same tag makes the connection a negative example and vice versa.

In a particular embodiment, a supervised machine learning algorithm is used with the training data obtained through farming. The supervised machine learning algorithm provides a statistically significant number of users several options of connections to interact with and monitors their response. In another embodiment, the supervised machine learning algorithm is trained entirely based on historical interactions of the user and the connections.

The above description of applying machine learning algorithms to determine a scoring function for top friends is equally applicable to the general problem of determining a scoring function for top objects. Keyword tagging associated with objects may be used to train the machine learning algorithms. Similarly, farmed data can be obtained with regard to objects by providing a statistically significant number of users options of several objects to interact with and monitoring their response.

The social endorsement module 140 provides a social context around advertisements displayed to a user. For example, an advertisement may include its viewing area endorsements from the connections of user. The endorsement may be in the form of a photo of the connection or simply a mention that the connection liked the advertisement.

The marketplace 150 is a social networking process to facilitate the process of selling goods and services to users of the social networking system 100. In some embodiments of the invention, the marketplace 150 displays to a user listings for goods and services from the user's top connections.

The search module 145 takes user queries as input and generates an output list of objects on the social networking system 100 that correspond most closely with the user queries. For example, a user query “car” may generate a list containing the user's connections with a car for sale, the user's connections who liked a car, and car manufacturers on the social networking system 100. In the specific instance of the user's connections with a car for sale or the user's connections who liked a car, the search module 145 may consult the top friend predictor 130 to determine which of the user's connections to prioritize in the output list.

The authentication manager 125 authenticates a user on user device 102 as being a registered user of the social networking system 100. The authentication manager 100 may allow a user to log into the social networking system 100 from any user device 102 that has an application supporting the social networking system 100. The application programming interface (API) 120 works in conjunction with the authentication manager 125 to validate users via external applications 104.

The social networking system 100 may also support one or more platform applications 145 and one or more external applications 104. Platform applications 145 are applications that operate within the social networking system 100 but may be provided by third parties other than an operator of the social networking system 100. Platform applications 145 may include social games, messaging services, and any other application that uses the social platform provided by the social networking system 100. The external application 104 may interact with the social networking system 100 via API 120. The external applications 104 can perform various operations supported by the API 120, such as enabling users to send each other messages through the social networking system 100 or showing advertisements routed through the social networking system 100.

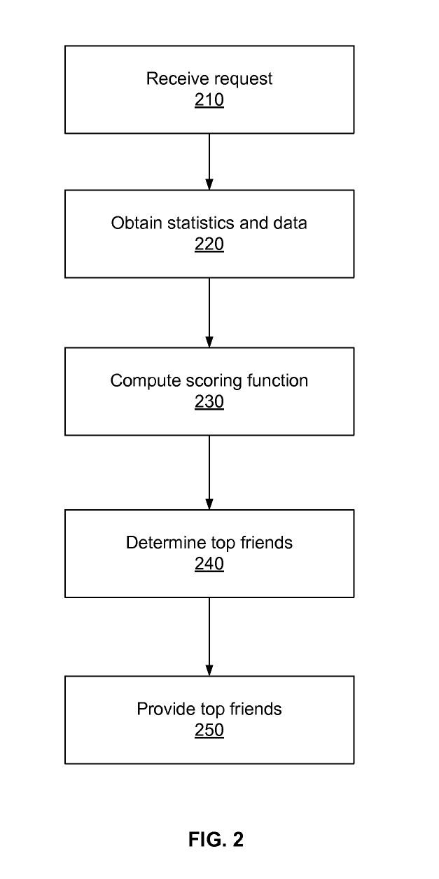

FIG. 2 is an exemplary flow chart of a process for determining a set of top friends based on a request, in accordance with an embodiment of the invention. The social networking system 100 receives 210 a request from a process for the top friends of a user. In certain embodiments of the invention, the requesting process may specify a number of top friends to be returned. The social networking system 100 then obtains 220 statistics related to the historical interactions of the user and the connections of the user along with static data from the profiles and passes that information to the top friend predictor 130. The top friend predictor 130 computes 230 a score for each connection and then determines 240 a list of top friends for the user based on the connections' scores. The top friend predictor 130 may then provide 250 the list of top friends as output to the requesting process. In some embodiments, the list of top friends provided as output is sorted by the score assigned to each top friend.

Various different processes may request the social networking system 100 for a list of top friends. For example, the processes may include those that implement basic social networking system functionality, such as newsfeed algorithms, ad targeting algorithms, and friend suggestion algorithms, among many others. The request process may also correspond to the social endorsement module 140 or the marketplace 150. Additionally, external applications 104 and platform applications 145 may also request the social networking system 100 for the top friends for a user.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for predicting a set of top friends for a user in a social networking system, the method comprising:
training a prediction model by:
identifying one or more users of a social networking system who have explicitly indicated a level of closeness of a relationship between the user and another user of the social networking system with whom the user has established a connection,
obtaining a training set of data that comprises information about the identified users and the corresponding relationships, and
training the prediction model using the obtained training set of data, wherein the prediction model computes a score indicative a level of closeness to a user of another user of the social networking system with whom that user has established a connection;
receiving a request from a process running on a computer system, the request for a set of top friends for a subject user of the social networking system;
predicting a set of top friends for the subject user by:
obtaining information about the subject user and one or more other users with whom the subject user has established a connection the social networking system,
providing the obtained information to the trained prediction model,
computing a score using the prediction model for each of a plurality of connections of the subject user, and
determining a set of top friends based on at least in part the computed scores; and
providing the determined set of top friends to the requesting process.

2. The method of claim 1, wherein for the identifying step, a user has explicitly indicated a level of closeness of a relationship with another user by adding the other user to a friends list associated with a predetermined keyword.

3. The method of claim 1, wherein for the identifying step, a user has explicitly indicated a level of closeness of a relationship with another user by excluding the other user from a friends list associated with a predetermined keyword.

4. The method of claim 1, wherein for the identifying step, a user has explicitly indicated a level of closeness of a relationship with another user by responding to a suggestion to interact with the other user.

5. The method of claim 1, wherein the trained prediction model is configured to receive a plurality of input signals based on historical information about interactions between the identified users and their connections and static information about profiles of the identified users and their connections.

6. The method of claim 1, wherein the obtained information comprises a plurality of input signals based on historical information about interactions between the subject user and the one or more other users.

7. The method of claim 6, wherein one or more of the interactions are selected from a group consisting of: one user observing information about another user; one user communicating with another user; two users coincidentally associated with a content item; and a farmed response of one user to a suggestion to interact with another user.

8. The method of claim 1, wherein the obtained information comprises a plurality of input signals based on static information about profiles of the subject user and the one or more other users.

9. The method of claim 1, wherein one or more elements of the obtained information are weighted by recency.

10. The method of claim 1, wherein one or more elements of the obtained information are normalized based on a frequency of a user's interactions in the social networking system.

11. The method of claim 1, wherein determining the set of top friends comprises identifying a connection as a top friend if the connection's computed score is above a threshold.

12. The method of claim 1, wherein determining the set of top friends comprises selecting a number of connections having the highest computed scores.

13. The method of claim 1, wherein the process comprises an advertisement creation process that is creating an advertisement for the subject user.

14. The method of claim 1, wherein the process is executed within the social networking system.

15. The method of claim 1, wherein the process is executed by a server external to the social networking system.

16. A method for predicting a set of top friends for a user in a social networking system, the method comprising:
receiving a request from a process running on a computer system, the request for a set of top friends for a subject user of the social networking system;
obtaining information about the subject user and one or more other users with whom the subject user has established a connection the social networking system;
providing the obtained information to a prediction model, wherein the prediction model has been trained by:
identifying one or more users of a social networking system who have explicitly indicated a level of closeness of a relationship between the user and another user of the social networking system with whom the user has established a connection,
obtaining a training set of data that comprises information about the identified users and the corresponding relationships, and
training the prediction model using the obtained training set of data, wherein the prediction model computes a score indicative a level of closeness to a user of another user of the social networking system with whom that user has established a connection;
computing a score using the prediction model for each of a plurality of connections of the subject user;
determining a set of top friends based on at least in part the computed scores; and
providing the determined set of top friends to the requesting process.

17. The method of claim 16, wherein the obtained information comprises a plurality of input signals based on:
historical information about interactions between the subject user and the one or more other users, wherein one or more of the interactions are selected from a group consisting of: one user observing information about another user; one user communicating with another user; two users coincidentally associated with a content item; and a farmed response of one user to a suggestion to interact with another user; and
static information about profiles of the subject user and the one or more other users.

18. The method of claim 16, wherein one or more elements of the obtained information are weighted by recency.

19. The method of claim 16, wherein one or more elements of the obtained information are normalized based on a frequency of a user's interactions in the social networking system.

20. The method of claim 16, wherein determining the set of top friends comprises identifying a connection as a top friend if the connection's computed score is above a threshold.

21. The method of claim 16, wherein determining the set of top friends comprises selecting a number of connections having the highest computed scores.

22. The method of claim 16, wherein the process comprises an advertisement creation process that is creating an advertisement for the subject user.

23. The method of claim 16, wherein the process is executed within the social networking system.

24. The method of claim 16, wherein the process is executed by a server external to the social networking system.

25. A method for training a prediction model for predicting a set of top friends for a user in a social networking system, the method comprising:
identifying one or more users of a social networking system who have explicitly indicated a level of closeness of a relationship between the user and another user of the social networking system with whom the user has established a connection;
obtaining a training set of data that comprises information about the identified users and the corresponding relationships; and
training the prediction model using the obtained training set of data, wherein the prediction model computes a score indicative a level of closeness to a user of another user of the social networking system with whom that user has established a connection.

26. The method of claim 25 wherein for the identifying step, a user has explicitly indicated a level of closeness of a relationship with another user by adding the other user to a friends list associated with a predetermined keyword.

27. The method of claim 25, wherein for the identifying step, a user has explicitly indicated a level of closeness of a relationship with another user by excluding the other user from a friends list associated with a predetermined keyword.

28. The method of claim 25, wherein for the identifying step, a user has explicitly indicated a level of closeness of a relationship with another user by responding to a suggestion to interact with the other user.

29. The method of claim 25, wherein the trained prediction model is configured to receive a plurality of input signals based on historical information about interactions between the identified users and their connections and static information about profiles of the identified users and their connections.

30. A method for predicting a plurality of top objects for a user from among objects in the social networking system, the method comprising:
receiving a request for a plurality of top objects for a user of a social networking system;
receiving statistics of the historical interactions of the user with a plurality of objects on the social networking system;
receiving static data for the user and the objects on the social networking system;
computing a score for each object through a scoring function based on the received statistics and static data, wherein the statistics are weighted by recency ;
determining a plurality of top objects based on at least in part the previously computed scoring functions; and
outputting the plurality of top objects.

31. The method of claim 30, wherein the objects comprise pages residing on the social networking system.

32. The method of claim 30, wherein the objects comprise search results requested by the user of the social networking system.

33. The method of claim 30, wherein the objects comprise applications on the social networking system.

34. The method of claim 30, wherein the objects are associated with locations for which users of the social networking system can check in.

35. The method of claim 30, wherein the objects comprise groups that users of the social networking system can join.
